(19) United States
(12) Patent Application Publication
(10) Pub. No.: US 2010/0252567 A1
(43) Pub. Date: Oct. 7, 2010

(54) PADDED LABELS DISPENSER AND METHOD OF DISPENSING LABELS

(75) Inventor: Patricia R. KONSTI, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/755,327

(22) Filed: Apr. 6, 2010

Related U.S. Application Data
(60) Provisional application No. 61/167,048, filed on Apr. 6, 2009.

(51) Int. Cl. G07F 11/02

(52) U.S. Cl. 221/307

(57) ABSTRACT

A refillable label dispenser for dispensing labels from a stack includes a bottom section and a pair of elastically deformable wing sections extending from opposite ends of the bottom section in overlapping spaced relation relative to the bottom section, thereby forming a generally flat C-shaped dispenser configuration. When the labels in the dispenser are exhausted, the wings are elastically flexed to allow the dispenser to accommodate a new stack of labels.

### CROSS-REFERENCE TO RELATED APPLICATION

This application claims priority to U.S. Provisional application Ser. No. 61/167,048, filed Apr. 6, 2009.

### FIELD OF THE INVENTION

The present invention relates to a dispenser for supplying reseparable adhesive labels.

### DESCRIPTION OF RELATED ART

U.S. Pat. No. 5,769,270 (Fujisawa et al.) discloses dispenser having a generally flat C-shaped configuration for individually dispensing sheets from a stack arranged within the dispenser.

### SUMMARY OF INVENTION

The present invention provides a dispenser for individually dispensing adhesive-backed labels (i.e., sometimes referred to as “self-stick labels”) from a stack of such labels and also provides a method for dispensing labels using such dispensers.

Each label comprises a sheet having a first major face and a second major face and a layer of adhesive on at least a portion of the second major face, each label has a tab portion and a label portion, and the labels are arranged in the stack in alternating orientation such that the tab portions of successive labels are positioned on alternating sides of the stack.

In use, the uppermost label is removed from the stack by lifting or pull on its tab portion, thereby causing the adhesive to separate from the first major face of the underlying label and then placed in desired position on a substrate and adhered with the adhesive. The tab portion is then separated from the label portion along the weakened separation line and removed.

Dispensers of the invention can be made in a variety of configurations as desired for selected applications.

### BRIEF DESCRIPTION OF DRAWING

The invention is further explained with reference to the drawing wherein:

FIG. 1 is a cross-sectional view of a portion of one embodiment of a pad of labels in accordance with the invention;

FIG. 2 is a cross-sectional view of a dispenser and pad of labels in accordance with the present invention.

These figures are not to scale and are intended to be merely illustrative and not limiting.

### DETAILED DESCRIPTION OF ILLUSTRATIVE EMBODIMENTS

Before the description of the present invention proceeds, it is to be noted that like parts are designated by like reference numerals throughout the accompanying drawings.

Labels

In one embodiment, a padded stack of labels used in the present the invention comprises a stack of a plurality of linerless labels, each label comprising a sheet having first and second major faces and a layer of adhesive on a portion but not all of the second major face of the sheet substantially completely covered with adhesive, the labels disposed in a stack with the adhesive of each label engaging the first major face of the underlying sheet in the stack. Each sheet comprises a label portion and a tab portion with the label portion typically being substantially completely covered with adhesive on its second major face and the tab portion having little, if any, adhesive on its second major face. The label portion and tab portion are typically separated by a weakened separation line, e.g., perforation line, by which a user may easily separate and remove the tab portion after adhering the label portion to a substrate as desired. The labels are arranged in alternating orientation such that the tabs of successive labels in the stack are positioned on alternating sides of the stack. Such padded labels are disclosed in U.S. Provisional Patent Application No. 61/114270, filed Nov. 13, 2008, (Attorney Docket No. 64940US002) which is incorporated by reference herein in its entirety.

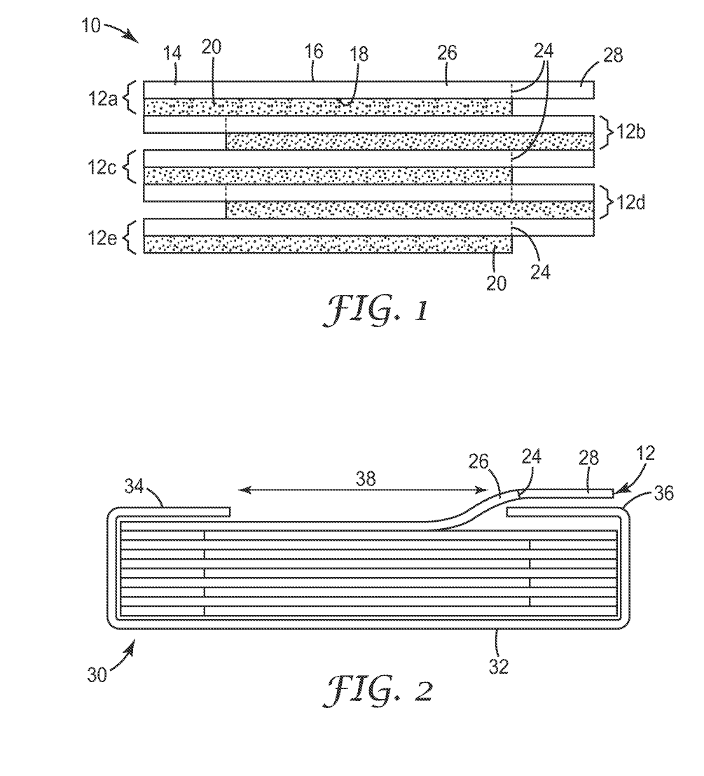

One embodiment of a pad of the invention is shown in FIG. 1 wherein pad 10 comprises a stack of a plurality of labels 12a, 12b, 12c, 12d, 12e, each label comprising a sheet 14 having first major face 16 and second major face 18 and a layer of adhesive 20 on a portion but not all of the second major face 18 of the sheet 14, the labels disposed in a stack with the adhesive of each label engaging the first major face of the underlying sheet in the stack. The adhesive of the bottom most sheet in the stack will typically engage a release liner (not shown) which is removed when the stack is installed into a dispenser of the invention (not shown). Each sheet has a weakened separation line 24 that divides it into label portion 26 and tab portion 28. The separation line is typically positioned substantially parallel to the boundary of the portion of the sheet which is coated with the adhesive 20 and the portion of the sheet which is not coated with the adhesive. In order to ensure that entirety of the bottom surface of the label portion is coated with adhesive, e.g., to ensure good bond performance to the desired substrate without undesirable edge lift, it is typically preferable to position the weakened separation line just inside the boundary of the adhesive coating. In some embodiments, positioning the weakened separation line at a position of up to about 2 millimeters into the portion of the sheet that is coated with adhesive is suitable. If the weakened separation line is positioned too deeply into the adhesive coated portion, performance may be undesirably impaired, e.g., there may be some tendency for the tab portions not to separate easily from underlying labels. If the weakened separation line is positioned too far into the tab area, leaving a portion of the label portion of the sheet without underlying adhesive, then the label may fail to adhere desirably to the substrate. Those skilled in the art will be able to readily determine suitable location for the weakened separation line relative to the boundary of the portion of the sheet that is coated with adhesive and the portion that is not.

As will be understood by those skilled in the art, the weakened separation line may be formed by any known means, e.g., formation of a perforation line with a series of cuts and ties, slitting the sheet, etc. In many embodiments, the separation line is substantially straight but it may be curved if desired. Typically it is desired that the separation line is such that the sheet will tear to leave a substantially smooth edge, e.g., by use of fine ties if a perforation line is used, and sufficiently deep slit if the separation line is a slit. The weakened separation line should not be so weak that the label cannot be removed from the stack as desired, but then should permit convenient separation, e.g., by folding over and ripping, of the tab portion from the label portion.

Other embodiments of padded self-stick labels which could be used in the present invention include the following. One, labels in which adhesive covers substantially all of the underside of the label and where the padded stack further comprises a small liner is applied to one end of the labels to facilitate release of an overlying label from an underling label. Prior to application to a substrate, the liner is removed such that the label may be securely bonded to the substrate. Two, a differential or gradient low adhesion backsize may be applied along an edge of each label for easy release in peeling but tighter release when popping up the next label. Three, an end of each self stick label may be embossed so as to allows easy release from the next, i.e., underlying, label. Four, a stand-off or stilt material may be coated on the adhesive along an edge to detackify or modify the amount of release.

Selection of the material to be used as sheets of labels of the invention will typically be made dependent in part upon the environment or application for which the labels are intended to be used, adhesive to be used, etc. Illustrative examples of suitable materials include paper, plastic films, metallic laminates, etc.

The adhesive will typically be a pressure sensitive adhesive selected dependent in part upon the application for which the label is intended, e.g., capable of achieving and sustaining desired adhesion under conditions of application and use of the article to which the label is applied, manner in which the label is to be applied, e.g., by machine or by hand, characteristics of the sheet, etc.

Dispenser

A dispenser for labels in accordance with one embodiment of the present invention will be described below with reference to FIG. 2. The dispenser 30 comprises a bottom section 32 and a pair of wing sections 34, 36, each one edge of which is flexibly connected with each of two edges, of the bottom section 32, opposed to each other lengthwise. The other edges of the wing sections 34, 36 are opposed to each other and form a label take-out opening 38 therebetween, thus forming an approximately flat C-shaped configuration. The dispenser accommodates a stack of labels 10 that are separably adhered to each other in zigzag orientation. The labels are taken out from the take-out opening one by one.

As seen in FIG. 2, label 12a extends out the take-out opening so that its tab portion 28 may be easily gripped. When the label is removed, the tab portion of the underlying label will be pulled so as to extend out the takeout opening, positioning it to be ready for dispensing.

Dispensers of the invention can be easily made such as by molding a one-piece elastic plastic film is molded to form the bottom section and wing sections. A portion corresponding to the wing section is elastically deformably folded back at the border between the bottom section and the wing section so as to cover the upper surface of the bottom section partly. Therefore, the wing section itself can be elastically bent in an approximately circular arc shape, and the wing section and the bottom section can be elastically bent to each other at the connecting portion between them. Preferably, a transparent or semi-transparent film made of polyvinyl chloride, polyester, polypropylene, or polycarbonate is used as the plastic film. In particular, polyvinyl chloride can be deformed at a low temperature and easily bent and moreover, has a high degree of transparency and inexpensive. Because the bottom section and wing section are transparent or semi-transparent, the amount of labels in the stack can be seen through the plastic film.

The plastic film composing the wing section is required to have an appropriate rigidity against a force applied to the wing section when taking out the label 10 from the take-out opening 38. The magnitude of stiffness which is necessary or preferred is dependent in parte upon the dimensions of the labels, the strength of adhesion of the label being dispensed to the label underlying it, and to the size of the takeout opening. If the rigidity of the plastic film is too low, the plastic film does not have a required mechanical strength and it is difficult for the dispenser to securely keep the labels therein and becomes difficult to take out the labels singly as desired during long use. If the thickness of the plastic film is too high, it may be difficult to bend it in a manufacturing process. Because both end portions of each wing section in the widthwise direction thereof are not connected with the upper surface of the bottom section, the wing section is not prevented from being elastically deformed.

The thickness of the connecting portion between the bottom section and the wing section is preferably thinner than that of each of the bottom section and the wing section, so as to easily bend and form the integral dispenser. Preferably, the elastic force can be easily controlled while having a sufficient mechanical strength for a dispenser, so that the label can be easily taken out. For the similar reason, a cutout can properly be formed at both ends and the middle part of the connecting portion between the wing section and the bottom section. The configuration of the cutout is not limited to a specified one, but can be, for example, circular, quadrilateral, triangular. The formation of the cutout prevents an extra force from acting at the connecting portion, specifically, the right and left opened ends of the wing section, resulting in improvement of its durability.

Preferably, the length of the take-out opening 38 and configuration (i.e., the relative size of the label portion and tab portion) of labels is such that the wings extend completely over the tab portion in to the label portion of each sheet with the exception of the top most sheet which extends outside the take out opening. In this configuration, effective dispensing of a single label at a time can be achieved effectively. If the length of the take-out opening is too great such that the wings don't extend over the tab portions on the labels, there will be a tendency for more than one label to be dispensed at a time. If the length of the take-out opening too small such that the wings extend too far beyond the tab portion, it is difficult to take out the label easily. Also, if the length of the take-out opening is too small, it is difficult to write on the label portion of the uppermost label before dispensing it.

As the uppermost label is pulled with one end projecting from the take-out opening disposed between the right and left wing sections, the label is taken out from the take-out opening without other labels in the pad being moved in the dispenser except the second, i.e., underlying label. One end of the underlying or second label is separably adhered to the other end of the first label. As the first label is taken out, the second label is flexed in an approximately U-shaped configuration and a section is elastically deformed in a circular arc shape. This is because the other end of the second label is adhered, namely, fixed to one end of a third label with adhesive agent. When the other end of the first label has been taken out from the take-out opening, one end of the second label projects from the take-out opening. Then, one end of the second label is pulled to take out the second label from the take-out opening with the other wing section being elastically deformed. Then, one end of the third label is projected from the take- out opening. In this manner, the labels are sequentially taken out from the take-out opening one by one.

The method of forming the bottom section and the wing sections is not limited to bending but can be formed by separately forming them and then adhering connecting portions between the bottom section and the wing sections to each other by adhesive agent or by melting the connecting portions by high frequency heating and then connecting them with each other.

The wing sections can be formed in continuation with the bottom section by the following method: That is, a transparent film made of soft polyvinyl chloride having a thickness of 200 μm punched into a rectangle of a predetermined size, for example, 8 cm by 10 cm by using a pressing machine. Then, by using a pressing machine, pressure is applied to the punched film while the film is being heated at 100° C. for 1 to 10 seconds to form a wing section on one side of the bottom. Then, a bundle of labels is inserted between the wing section and the bottom section. Then, a second wing section is formed on the other side of the bottom section similarly by using the pressing machine. The pad of labels can be inserted between the wing sections and the bottom section after the dispenser is formed.

Preferably, each wing section is made of transparent material which allows labels accommodated between the wing sections and the bottom section to be seen through the wing sections.

Preferably, the labels are fixed so as to be substantially unmovable with respect to the bottom section.

Preferably, the bottom section and each wing section can be each made of a rectangular transparent plastic film; only one edge of each wing section can be elastically deformably connected with one end of the bottom section; and the width of the bottom section and that of each wing section can be at least twice as large as that of each label.

According to the above construction, the dispenser comprises the bottom section and the wing section formed on each side of the bottom section, thus forming the approximately flat C-shaped configuration so as to accommodate a stack of labels between the bottom section and the wing sections, and the take-out opening does not project from the upper surface of the dispenser.

Because the wing section is elastically deformable, the wing sections are pressed upward alternately when labels are taken out from the take-out opening. In this manner, the labels can be taken out one by one from the take-out opening. Further, when the labels accommodated in the dispenser are exhausted, the wings are elastically flexed to accommodate new labels easily. That is, the dispenser can be repeatedly used.

If the bottom section and/or the wing sections are made of transparent material or semi-transparent material, the amount of labels remaining in the dispenser can be recognized at a glance.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A refillable sheet dispenser having a generally flat C-shaped configuration for individually dispensing sheets from a stack arranged within the dispenser, comprising:
(a) a generally planar bottom section having remote ends;
(b) a pair of elastically deformable wing sections each extending from a respective bottom section remote end toward the other wing section in overlapping spaced relation relative to said bottom section, thereby allowing a stack of sheets to be accommodated between the wing sections and the bottom section, each said wing section having a terminal edge spaced from and opposing the other wing section terminal edge, thereby defining an opening therebetween, whereby as sheets are dispensed through the opening, each wing section is alternately urged pivotally away from the bottom section, and further whereby when said stack of sheets is exhausted, the wing sections may be elastically flexed to allow a new stack to be accommodated within the dispenser; and
(c) a stack of self-stick labels each comprising a sheet having a first major face and a second major face and a layer of adhesive on at least a portion of said second major face, each said label having a tab portion and a label portion and wherein said labels are arranged in alternating orientation such that the tab portions of successive labels are positioned on alternating sides of the stack;
wherein said labels and said wings are configured such that tab portion of each label is substantially covered by a wing with the exception of a label extending thought said opening.

2. A dispenser as defined in claim 1 wherein said bottom section and said wing sections are integrally formed of a plastic film having a generally uniform thickness.

3. A dispenser as defined in claim 2 and further including a connecting portion arranged between said bottom section and each said wing section having a thickness less than the thickness of said bottom section and each said wing section, whereby said plastic film easily bends to form the dispenser.

4. A dispenser as defined in claim 1 wherein each said wing section is formed of a transparent material, thereby allowing the sheets accommodated between said wing section and said bottom section to be seen through said wing sections.

5. A dispenser as defined in claim 1 wherein the stack of sheets includes a lower-most sheet fixed relative to said bottom section.

6. A dispenser as defined in claim 1 and further including a clip arranged to allow the dispenser to be mounted on a supporting structure.
